(19) United States
(12) Patent Application Publication
(10) Pub. No.: US 2015/0099551 A1
(43) Pub. Date: Apr. 9, 2015

(54) METHOD FOR USING A FEMTOCELL BASE STATION AND A USER EQUIPMENT IN A PUBLIC LAND MOBILE NETWORK, FEMTOCELL BASE STATION, PUBLIC LAND MOBILE NETWORK, PROGRAM AND COMPUTER PROGRAM PRODUCT

(71) Applicant: T-MOBILE CZECH REPUBLIC A.S., 149 00 Praha 4 (CZ)

(72) Inventor: David Bohaty, Brezineves (CZ)

(73) Assignee: T-MOBILE CZECH REPUBLIC A.S., 1419 00 Praha 4 (CZ)

(21) Appl. No.: 14/398,766

(22) PCT Filed: May 2, 2013
(86) PCT No.: PCT/EP2013/059135

§ 371 Date: Nov. 4, 2014

(30) Foreign Application Priority Data
May 4, 2012 (EP) 12003456.6

(51) Int. Cl. H04W 64/00; H04W 84/04; H04W 88/08

(52) U.S. Cl. CPC H04W 64/00; H04W 88/08; H04W 84/042
USPC 455/456.5

(57) ABSTRACT

A method for using a femtocell base station and a user equipment in a public land mobile network includes: initiating a location update signalling procedure between the femtocell base station and the user equipment, wherein at least one previous location information of the user equipment is transmitted from the user equipment to the femtocell base station, the at least one previous location information being derived from or being a part of an indication regarding a last successfully visited location of the user equipment; determining whether the at least one previous location information matches at least one permission information; and continuing the location update signalling procedure in response to determining that the at least one previous location information matches the at least one permission information.

### CROSS-REFERENCE TO PRIOR APPLICATIONS

This application is a U.S. National Phase application under 35 U.S.C. §371 of International Application No. PCT/EP2013/059135, filed on May 4, 2013, and claims benefit to European Patent Application No. EP 12003456.6, filed on May 2, 2013. The International Application was published in English on Nov. 7, 2013 as WO 2013/164398 under PCT Article 21(2)

### FIELD

The present invention relates a method for using a femtocell base station and a user equipment in a public land mobile network, wherein the femtocell base station is connected to the public land mobile network via a femtocell gateway entity.

The present invention furthermore relates to a femtocell base station to be used with a public land mobile network, and to a public land mobile network, wherein a femtocell base station is connected to the public land mobile network.

### BACKGROUND

A femtocell, herein after also called a femtocell base station, is a small base station that has a very small range of the radio coverage area. Typically, such a femtocell base station is placed at a subscriber's premises and the subscriber installs the femtocell base station without operator control, i.e. without the control or the help of the network operator of a public land mobile network with which the femtocell base station should be used.

A problem with customer self installation is that the operator of the public land mobile network has no control over the location of such a femtocell base station. A significant problem can arise in case that the subscriber, i.e. the owner of the femtocell base station, moves the femtocell base station out of the home country of the operator of the public land mobile network and places the femtocell base station in a different location, especially in a foreign country. The problem is aggravated in case that the femtocell base station is operated in a mode of operation such that the femtocell base station is accessible by an arbitrary subscriber (i.e. corresponds to an open mode of operation of the femtocell base station). In such a situation, user equipments of a foreign operator (i.e. a network operator of a public land mobile network in the foreign country, different from the network operator with which the femtocell base station has been initially deployed) can start camping on and using such a femtocell base station. As a consequence thereof, such user equipments of a foreign operator enter into a roaming mode when using the femtocell base station without either the subscriber of the foreign user equipment or the subscriber that owns the femtocell base station being aware of such a roaming mode. Such a situation can have serious consequences, such as significant roaming costs for subscribers that reach the home country (originally associated with the femtocell base station), or for example an emergency center, which is for such subscribers a foreign network and does therefore not correspond to their intention of reaching an emergency center in their home country.

### SUMMARY

In an embodiment, the invention provides a method for using a femtocell base station and a user equipment in a public land mobile network. The femtocell base station is connected to the public land mobile network via a femtocell gateway entity. At least one permission information is related to the femtocell base station. The method includes: initiating a location update signalling procedure between the femtocell base station and the user equipment, wherein at least one previous location information of the user equipment is transmitted from the user equipment to the femtocell base station, the at least one previous location information being derived from or being a part of an indication regarding a last successfully visited location of the user equipment; determining whether the at least one previous location information matches the at least one permission information; continuing the location update signalling procedure in response to determining that the at least one previous location information matches the at least one permission information; and discontinuing the location update signalling procedure in response to determining that the at least one previous location information does not match the at least one permission information. The at least one permission information corresponds to at least one Mobile Country Code or to at least one Mobile Country Code and Mobile Network Code. The at least one previous location information corresponds to a Mobile Country Code or to a Mobile Country Code and a Mobile Network Code of the last successfully visited location of the user equipment.

### BRIEF DESCRIPTION OF THE DRAWINGS

The present invention will be described in even greater detail below based on the exemplary figures. The invention is not limited to the exemplary embodiments. All features described and/or illustrated herein can be used alone or combined in different combinations in embodiments of the invention. The features and advantages of various embodiments of the present invention will become apparent by reading the following detailed description with reference to the attached drawings which illustrate the following:

FIG. 1 schematically illustrates an example of a system architecture and an example of a message flow according to the present invention.

### DETAILED DESCRIPTION

In an embodiment, the present invention provides a simple solution for reducing risks associated with the functionality of using femtocell base stations as access points, especially in the case, that such femtocell base stations are originally operated in a first country and then relocated to a different country.

In an embodiment, the present invention provides a method for using a femtocell base station and a user equipment in a public land mobile network, wherein the femtocell base station is connected to the public land mobile network via a femtocell gateway entity, wherein at least one permission information is related to the femtocell base station, wherein the method comprises the following steps:

in a first step, a location update signalling procedure is initiated between the femtocell base station and the user equipment, wherein at least one previous location information of the user equipment is transmitted from the user equipment to the femtocell base station, the at least one previous location information being derived from or being a part of an indication regarding the last successfully visited location of the user equipment,

in a second step, a test is performed whether the at least one previous location information matches the permission information,

in a third step, the location update signalling procedure is continued in case that the at least one previous location information matches the permission information, and the location update signalling procedure is discontinued in case that the at least one previous location information does not match the permission information.

In another embodiment, the present invention provides a method for using a femtocell base station and a user equipment in a public land mobile network, wherein the femtocell base station is connected to the public land mobile network via a femtocell gateway entity, wherein at least one permission information is related to the femtocell base station, wherein the method comprises the following steps:

in a first step, a location update signalling procedure is initiated between the femtocell base station and the user equipment, wherein at least one previous location information of the user equipment is transmitted from the user equipment to the femtocell base station, the at least one previous location information being derived from or being a part of an indication regarding the last successfully visited location of the user equipment,

in a second step, a test is performed whether the at least one previous location information matches the permission information,

in a third step, the location update signalling procedure is continued in case that the at least one previous location information matches the permission information, and the location update signalling procedure is discontinued in case that the at least one previous location information does not match the permission information, wherein the permission information corresponds to at least one Mobile Country Code or to at least one Mobile Country Code and Mobile Network Code, and wherein the at least one previous location information corresponds to the Mobile Country Code or to the Mobile Country Code and the Mobile Network Code of the last successfully visited location of the user equipment.

According to the present invention, it is advantageously possible that an analysis of the value of the last visited location area of a user equipment trying to use the femtocell base station as an access point to access a public land mobile network (the value of the last visited location area is sent as part of the location update signalling) is conducted such that unwanted roaming activities of such a contact between a user equipment and the femtocell base station can be avoided. Such a situation can especially occur in case that the femtocell base station is originally deployed in a first country and then taken to a second country without a proper change of the corresponding configuration of the femtocell base station.

Conventionally available mechanisms to prevent unwanted roaming costs include an autonomous check of the location of the femtocell base station, e.g. in the form of a scan of the surrounding macro network (of the public land mobile network in the country to which the femtocell base station has been taken) or a satellite-aided triangulation (e.g. by a GPS receiver). However, such methods fail in case that the femtocell base station is located in an area without the network coverage of a public land mobile network, especially a surrounding macro network, and in a location where GPS signals cannot be received or are too weak to be received, such as a location in a basement of a building or in remote areas. In order to prevent unwanted roaming activities, it is furthermore known to check the value of the subscriber identity (such as the IMSI value) which is sent by the user equipment while it tries to access the femtocell base station. The subscriber identity also comprises the identification of the subscriber's home network, which corresponds in case of a relocation of the femtocell base station, generally to a public land mobile network in the country to where the femtocell base station has been transferred. In such a case, only subscribers of the home network are allowed to access the femtocell base station which will effectively prevent unwanted roaming activities of subscribers of other networks in case the femtocell base station is taken into a foreign location. However, this solution would have the side effect, that it also prevents roaming activities of subscribers to access the femtocell base station in case that the femtocell base station is correctly installed in the home network, i.e. such a solution corresponds to restricting the use of the femtocell base station only to those user equipments that are subscribed to the home network of the femtocell base station.

According to the present invention, it is advantageously possible to base the decision of whether roaming activities should be allowed or not on the value of the previous location information, preferably being derived from the last visited location area, i.e. the decision is based on the result of a test, whether the at least one previous location information of the user equipment trying to access the femtocell base station corresponds or matches the permission information that is related to the femtocell base station, for example in the form of a memory location within the femtocell base station storing the permission information or in the form of the public land mobile network (working with the femtocell base station) storing the permission information.

According to the present invention, or at least according to a preferred embodiment of the present invention, the permission information corresponds to at least one Mobile Country Code or to at least one Mobile Country Code and Mobile Network Code which means that the permission information will contain only the Mobile Country Core or Mobile Country Code and Mobile Network Code of the mobile networks that can be deployed in the same locations as the femtocell base station that are deployed correctly according to the rules defined by the operator of the mobile network to which the femtocell base station belongs.

According to the present invention, it is preferred that the permission information is stored in the femtocell base station and the test according to the second step of the inventive method is performed in the femtocell base station.

This has the advantage that the test according to the second step can occur locally such that potential additional signalling traffic can be avoided by quickly discontinuing the location update signalling procedure in case that there is no match between the at least one previous location information and the permission information.

According to another embodiment of the present invention, it is preferred that the permission information is stored in the femtocell gateway entity or in the public land mobile network, wherein the test according to the second step is performed in the femtocell gateway entity and/or in the public land mobile network.

This solution means that it is the entity which stores the permission information that is conducting the test according to the second step of the inventive method, i.e. either the femtocell gateway entity (storing the information and performing the test) or the public land mobile network. Thereby it is advantageously possible to centrally store the permission information (i.e. not in the femtocell base station) such that it is comparably easy to administrate a plurality of femtocell base stations.

Furthermore, it is preferred according to the present invention that the permission information corresponds to at least one (or a list of) Mobile Country Code or to at least one Mobile Country Code and Mobile Network Code, and wherein the at least one previous location information corresponds to the Mobile Country Code or to the Mobile Country Code and the Mobile Network Code of the last successfully visited location of the user equipment.

It is thereby advantageously possible to use such an indication of the country (by using only the Mobile Country Code) and/or of the country and the mobile network (by using the Mobile Country Code and the MNC) to avoid unwanted roaming activities. It is possible according to the present invention that other information or pieces of information is/are exchanged between the user equipment and the femtocell base station to be used as the permission information and the last successfully visited location of the user equipment.

According to the present invention, it is furthermore preferred that in case that the at least one previous location information does not match the permission information, either:

a change of the femtocell base station to a closed mode of operation occurs such that access to the public land mobile network via the femtocell base station is possible only for a predefined set of other user equipments, or

a change of the femtocell base station to a reduced mode of operation occurs for the user equipment, or

the radio interface of the femtocell base station is disabled.

According to the present invention, it is thereby advantageously possible to change the behaviour of the femtocell base station such that in a reliable manner unwanted roaming activities can be suppressed.

According to a further preferred embodiment of the present invention, in case that the at least one previous location information does not match the permission information, at least one out of the following actions is performed:

a counter related to the unsuccessful match between the at least one previous location information of the user equipment and the permission information is changed,

a message related to the unsuccessful match between the at least one previous location information of the user equipment and the permission information is sent to a predefined target address.

It is thereby advantageously possible according to the present invention to flexibly react in case of an unsuccessful match between the at least one previous location information on the one hand and the permission information on the other hand. For example, according to the present invention at a first occurrence of the situation that the at least one previous location information does not match the permission information only the counter related to the unsuccessful match between the at least one previous location information of the user equipment and the permission information is changed (e.g. increased or decreased) and after the counter reaching a predefined threshold value (i.e. after a plurality of such situations (e.g. 2 or 3 or 4 or 5 or 6 or 10) that the at least one previous location information does not match the permission information) the location update signalling procedure is discontinued and/or

a change of the femtocell base station to a closed mode of operation occurs, or

a change of the femtocell base station to a reduced mode of operation occurs for the user equipment, or

the radio interface of the femtocell base station is disabled.

It is preferred according to the present invention that the location update signalling procedure is discontinued and/or

a change of the femtocell base station to a closed mode of operation occurs, or

a change of the femtocell base station to a reduced mode of operation occurs for the user equipment, or

the radio interface of the femtocell base station is disabled

provided that the counter reaches the predefined threshold value or provided that a predefined data volume is transmitted or requested to be transmitted via the femtocell base station.

According to the present invention, it is furthermore preferred that the counter value is stored in a memory location that is either located in the femtocell base station or located outside the femtocell base station (e.g. in the femtocell gateway entity) but associated with the femtocell base station. According to a preferred embodiment of the present invention, the counter value is cleared once a successful location update is performed and/or after a predetermined time period.

It is furthermore preferred according to the present invention that the public land mobile network comprises a position information related to the current position of the femtocell base station, wherein in case of a confirmation of the position information, the method comprises a fourth step, wherein in the fourth step, the test according to the second step is prevented for such a location update signalling procedure between the femtocell base station and the user equipment that occurs subsequent to the confirmation of the position information.

It is thereby advantageously possible according to the present invention that the protection mechanism according to the present invention (which should be invoked in case of the femtocell base station being at an unknown position, i.e. unknown to the public land mobile network associated to the femtocell base station) is released and additional roaming traffic even in case that the test according to the second step of the inventive method would yield a negative result allowed, i.e. in case the at least one previous location information does not match the permission information.

The present invention furthermore also relates to a femtocell base station to be used with the public land mobile network, wherein the femtocell base station is connected to the public land mobile network via a femtocell gateway entity, wherein at least one permission information is related to the femtocell base station, wherein the femtocell base station is configured such that a location update signalling procedure is initiated between the femtocell base station and the user equipment, wherein at least one previous location information of the user equipment is transmitted from the user equipment to the femtocell base station, the at least one previous location information being derived from or being a part of an indication regarding the last successfully visited location of the user equipment, wherein the femtocell base station is furthermore configured such that a test is performed whether the at least one previous location information matches the permission information, and wherein the femtocell base station is furthermore configured such that the location update signalling procedure is continued in case that the at least one previous location information matches the permission information, and the location update signalling procedure is discontinued in case that the at least one previous location information does not match the permission information.

The present invention furthermore additionally relates to a femtocell base station to be used with the public land mobile network, wherein the femtocell base station is connected to the public land mobile network via a femtocell gateway entity, wherein at least one permission information is related to the femtocell base station, wherein the femtocell base station is configured such that a location update signalling procedure is initiated between the femtocell base station and the user equipment, wherein at least one previous location information of the user equipment is transmitted from the user equipment to the femtocell base station, the at least one previous location information being derived from or being a part of an indication regarding the last successfully visited location of the user equipment, wherein the femtocell base station is furthermore configured such that a test is performed whether the at least one previous location information matches the permission information, and wherein the femtocell base station is furthermore configured such that the location update signalling procedure is continued in case that the at least one previous location information matches the permission information, and the location update signalling procedure is discontinued in case that the at least one previous location information does not match the permission information, wherein the permission information corresponds to at least one Mobile Country Code or to at least one Mobile Country Code and Mobile Network Code, and wherein the at least one previous location information corresponds to the Mobile Country Code or to the Mobile Country Code and the Mobile Network Code of the last successfully visited location of the user equipment.

With such a femtocell base station, it is advantageously possible according to the present invention that unwanted roaming traffic can be effectively prevented in case that the femtocell base station has been relocated and the location of the femtocell base station is unknown to the public land mobile network associated to the femtocell base station.

Also with regard to the femtocell base station, it is preferred that the permission information corresponds to at least one Mobile Country Code or to at least one Mobile Country Code and Mobile Network Code, and wherein the at least one previous location information corresponds to the Mobile Country Code or to the Mobile Country Code and the Mobile Network Code of the last successfully visited location of the user equipment.

The present invention furthermore also relates to a public land mobile network, wherein a femtocell base station is connected to the public land mobile network via a femtocell gateway entity, wherein at least one permission information is related to the femtocell base station, wherein the public land mobile network is configured such that a location update signalling procedure is initiated between the femtocell base station and the user equipment, wherein at least one previous location information of the user equipment is transmitted from the user equipment to the femtocell base station, the at least one previous location information being derived from or being a part of an indication regarding the last successfully visited location of the user equipment, wherein the public land mobile network is furthermore configured such that a test is performed whether the at least one previous location information matches the permission information, and wherein the public land mobile network is furthermore configured such that the location update signalling procedure is continued in case that the at least one previous location information matches the permission information, and the location update signalling procedure is discontinued in case that the at least one previous location information does not match the permission information.

The present invention furthermore additionally relates to a public land mobile network, wherein a femtocell base station is connected to the public land mobile network via a femtocell gateway entity, wherein at least one permission information is related to the femtocell base station, wherein the public land mobile network is configured such that a location update signalling procedure is initiated between the femtocell base station and the user equipment, wherein at least one previous location information of the user equipment is transmitted from the user equipment to the femtocell base station, the at least one previous location information being derived from or being a part of an indication regarding the last successfully visited location of the user equipment, wherein the public land mobile network is furthermore configured such that a test is performed whether the at least one previous location information matches the permission information, and wherein the public land mobile network is furthermore configured such that the location update signalling procedure is continued in case that the at least one previous location information matches the permission information, and the location update signalling procedure is discontinued in case that the at least one previous location information does not match the permission information, wherein the permission information corresponds to at least one Mobile Country Code or to at least one Mobile Country Code and Mobile Network Code, and wherein the at least one previous location information corresponds to the Mobile Country Code or to the Mobile Country Code and the Mobile Network Code of the last successfully visited location of the user equipment.

With such a public land mobile network, it is advantageously possible according to the present invention that unwanted roaming traffic can be avoided.

Additionally, the present invention relates to a program comprising a computer-readable program code which, when executed on a computer or on a femtocell base station or on a network entity of a public land mobile network, causes the computer or the femtocell base station or the network entity of the public land mobile network to perform an inventive method.

Still additionally, the present invention relates to a computer program product for using a femtocell base station with a public land mobile network, the computer program product comprising a computer program stored on a storage medium, the computer program comprising program code which, when executed on a computer or on a femtocell base station or on a network entity of a public land mobile network, causes the computer or the femtocell base station or the network entity of the public land mobile network to perform an inventive method.

These and other characteristics features and advantages of the present invention will become apparent from the following detailed description, taken in conjunction with the accompanying drawings, which illustrate, by way of example, the principles of the invention. The description is given for the sake of example only, without limiting the scope of the invention. The reference figures quoted below refer to the attached drawings.

The present invention will be described with respect to particular embodiments and with reference to certain drawings but the invention is not limited thereto but only by the claims. The drawings described are only schematic and are non-limiting. In the drawings, the size of some of the elements may be exaggerated and not drawn on scale for illustrative purposes.

Where an indefinite or definite article is used when referring to a singular noun, e.g. “a”, “an”, “the”, this includes a plural of that noun unless something else is specifically stated.

Furthermore, the terms first, second, third and the like in the description and in the claims are used for distinguishing between similar elements and not necessarily for describing a sequential or chronological order. It is to be understood that the terms so used are interchangeable under appropriate circumstances and that the embodiments of the invention described herein are capable of operation in other sequences than described or illustrated herein.

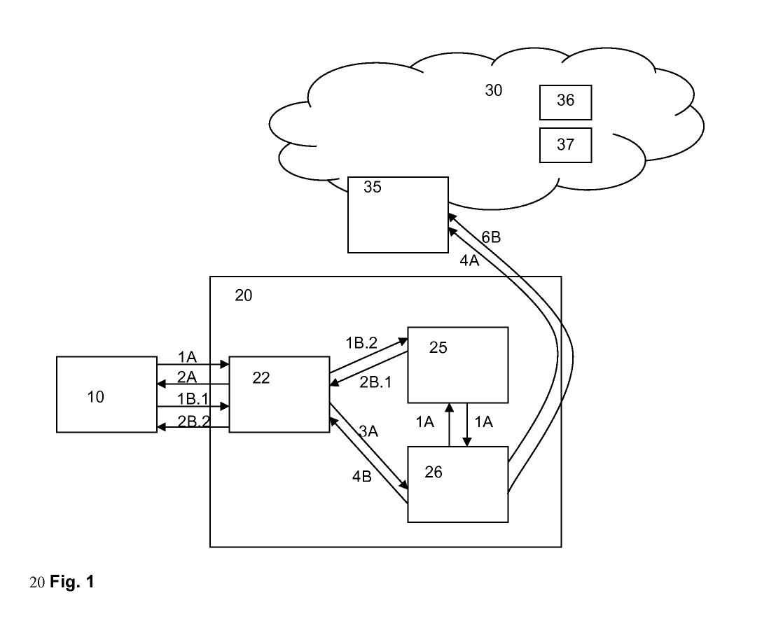

In FIG. 1, an example of a system architecture and an example of a message flow according to the present invention is schematically shown.

According to FIG. 1, a user equipment 10 is connected to a femtocell base station 20. The femtocell base station 20 is connected to a public land mobile network 30, especially via a femtocell gateway entity 35. The public land mobile network 30 typically comprises a multitude of network entities, where in FIG. 1 only two network entities are schematically and exemplarily shown, namely an MSC (Mobile Switching Center) 36 and a SGSN (Serving GPRS Support Node) 37. The femtocell base station 20 preferably comprises a femtocell 22 or a femtocell component 22, i.e. comprising an antenna and further circuitry regarding the processing and/or generation of radio frequency signals. Furthermore, the femtocell base station 20 comprises a femtocell gateway component 25 and a femtocell management system 26.

Typically, femtocells or femtocell base stations 20 have assigned a unique location area (LA) and routing area (RA) value in order to force the user equipment 10 to perform location area update and/or to perform routing area update once it enters the coverage area of the femtocell base station 20. This assures that the associated public land mobile network 30 is aware that the user equipment 10 is using the femtocell base station 20, i.e. the femtocell, and proper routing (especially of backhaul call data transmission) is configured inside the public land mobile network 30.

During the location area update and/or the routing area update procedures (both procedures are in the context of the present invention also referred to as location update signalling procedure), the last successfully visited location of the user equipment 10 (i.e. a location area information such as the LAI value (location area identifier) in case of a location area update procedure and a routing area indication such as the RAI value (routing area identifier) in case of a routing area update procedure is sent to the network, i.e. to the femtocell base station 20, including the Mobile Country Code (MCC) and Mobile Network Code (MNC) of the last visited location area and/or routing area.

It is not expected according to the present invention that the user equipment 10 which tries to connect to the public land mobile network 30 via the femtocell base station 20 will make the first roaming attach in the foreign country to which the femtocell base station 20 has been transferred. Therefore, it can be expected that the last visited location, i.e. the previous location information (such as the location area identifier or the routing area identifier and the like) which is sent during the location update signalling procedure (such as the location area update procedure or the routing area update procedure) will contain the same Mobile Country Code as the public land mobile network 30 with which the femtocell base station 20 is associated or connected. In case that the previous location information of the user equipment 10 does not necessarily correspond to the same Mobile Network Code, roaming subscribers which were previously roaming in another network in the same Mobile Country Code region can change to the public land mobile network 30 which is associated with the femtocell base station 20, i.e. these user equipments 10 can change the roaming operator to the femtocell operator.

In the following, the functionality of the inventive method according to the present invention is described with respect to FIG. 1 for two different embodiments of the present invention. According to a first embodiment of the present invention, the user equipment 10 enters the radio coverage area of the femtocell base station 20, recognizes a new location area (or routing area) and initiates a location area updating procedure (or a routing area updating procedure) by sending a location area update request message (or a routing area update request message) to the femtocell base station 20 including the value of the last successfully visited location information (i.e. the LAI, Location Area Identifier and/or the RAI, Routing Area Identifier) which includes the value of the Mobile Country Code of the previous successful registration of the user equipment 10 (i.e. the previous location information). This corresponds to a first message 1A from the user equipment 10 to the femtocell component 22 of the femtocell base station 20. According to the first embodiment, the femtocell component 22, i.e. the femtocell base station 20, analyses the indication regarding the last successfully visited location of the user equipment 10, i.e. especially the location area update request message (and/or the routing area update request message). After recognizing that the previous location information being derived from or being a part of an indication regarding the last successfully visited location of the user equipment 10 does not match a permission information related to the femtocell base station 20, the location update signalling procedure (or routing area update signalling procedure) is rejected by means of a second message 2A from the femtocell base station 20 to the user equipment 10. The at least one permission information related to the femtocell base station 20 is preferably an allowed MCC information (Mobile Country Code) which is either stored in the femtocell base station 20 or in the femtocell gateway entity 35 or in a network entity of the public land mobile network 30. As permission information, there can be a plurality of Mobile Country Code values accepted to be used. In case that the test performed whether the at least one previous location information matches the permission information yields a positive result, the location update signalling procedure is continued and the user equipment 10 is finally connected to the public land mobile network 30 via the femtocell base station 20.

According to a second embodiment of a message flow between the user equipment 10 and the femtocell base station 20, the user equipment 10 enters the femtocell base station 20 coverage area, recognizes a new location indication (e.g. a new location area identifier and/or a new routing area identifier) and sends a location area update request message (or a routing area update request message) by means of a third message 1B.1 to the femtocell base station 20, especially to the femtocell component 22 including the value of the last successfully visited location (especially a location area identifier or a routing area identifier), which especially includes an MCC value as the previous location information. According to the second embodiment, the femtocell component 22 forwards the location area update request to the femtocell gateway component 25 via a fourth message 1B.2. The femtocell gateway component 25 analyses the previous location information being derived from or being a part of an indication regarding the last successfully visited location of the user equipment 10. In case this information does not match the permission information related to the femtocell base station 20, the location update signalling procedure is rejected by means of a fifth message 2B.1 between the femtocell gateway component 25 and the femtocell component 22. The femtocell component 22 forwards this rejection message to the user equipment 10 via a sixth message 2B.2.

In all such cases of a rejection of a location update signalling procedure (be it according to the first embodiment involving the first and second messages 1A, 2A or be it according to the second embodiment involving the third message 1B.1, the forth message 1B.2, the fifth message 2B.1 and the sixth message 2B.2) a plurality of further options and reactions of the femtocell base station 20 is possible to be realized according to the present invention.

Optionally, the femtocell base station 20 enters a closed mode of operation so that only user equipments that identify themselves, e.g. by means of an IMSI number matching with one value of a predefined list of allowed IMSI numbers, to use the femtocell. Alternatively, the femtocell base station disables its radio interface completely after a rejection of a location update signalling procedure. According to a further optional behaviour of the femtocell base station 20, the femtocell base station disables the package switched service and starts a monitoring of all call set-up requests and rejects any requests that do not have target numbers belonging to a predefined list of numbers or alternatively redirects such requests to a predefined phone number or pre-recorded message. Furthermore alternatively, it is possible and preferred according to the present invention that the femtocell base station sends a seventh message 3A to the femtocell management system 26 to provide information about a rejection event. According to still another optional behaviour of the femtocell base station 20, the femtocell management system 26 sends an SMS message containing information about the new femtocell configuration (e.g. the invocation of the closed mode or invocation of the disabled radio interface or the like) to a subscriber which is predefined as being responsible for the femtocell base station 20 by means of an eighth message 4A to the femtocell gateway entity 35.

Furthermore optionally, the femtocell management system 26 instructs the femtocell component 22 to reconfigure itself by means of a ninth message 4B with a new configuration which includes optionally a closed-mode operation in which only user equipments identifying themselves with a valid IMSI included in a predefined list are allowed to use the femtocell base station 20. Alternatively, the femtocell base station disables its radio interface. Furthermore optionally, the femtocell management system 26 provides the femtocell gateway 25 with a new configuration information of the femtocell base station 20 in question by means of a tenth message 5B with a new configuration (which can alternatively also include a closed-mode operation (in which only user equipments identifying themselves with a valid IMSI included in a predefined list are allowed to use the femtocell base station 20) or a mode of operation with disabled radio interface). According to still another optional behaviour of the femtocell base station 20, the femtocell management system 26 sends an SMS message containing information about the new femtocell configuration (e.g. the invocation of the closed mode or invocation of the disabled radio interface or the like) to a subscriber which is predefined as being responsible for the femtocell base station 20 by means of an eleventh message 6B to the femtocell gateway entity 35.

While the invention has been illustrated and described in detail in the drawings and foregoing description, such illustration and description are to be considered illustrative or exemplary and not restrictive. It will be understood that changes and modifications may be made by those of ordinary skill within the scope of the following claims. In particular, the present invention covers further embodiments with any combination of features from different embodiments described above and below. Additionally, statements made herein characterizing the invention refer to an embodiment of the invention and not necessarily all embodiments.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

1. A method for using a femtocell base station and a user equipment in a public land mobile network, wherein the femtocell base station is connected to the public land mobile network via a femtocell gateway entity, wherein at least one permission information is related to the femtocell base station, the method comprising:
initiating a location update signalling procedure between the femtocell base station and the user equipment, wherein at least one previous location information of the user equipment is transmitted from the user equipment to the femtocell base station, the at least one previous location information being derived from or being a part of an indication regarding a last successfully visited location of the user equipment;
determining whether the at least one previous location information matches the at least one permission information
continuing the location update signalling procedure in response to determining that the at least one previous location information matches the at least one permission information; and
discontinuing the location update signalling procedure in response to determining that the at least one previous location information does not match the at least one permission information;
wherein the at least one permission information corresponds to at least one Mobile Country Code or to at least one Mobile Country Code and Mobile Network Code, and wherein the at least one previous location information corresponds to a Mobile Country Code or to a Mobile Country Code and a Mobile Network Code of the last successfully visited location of the user equipment.

2. The method according to claim 1, wherein the at least one permission information is stored in the femtocell base station, and wherein the determining is performed in the femtocell base station.

3. The method according to claim 1, wherein the at least one permission information is stored in the femtocell gateway entity or in the public land mobile network, and wherein the determining is performed in the femtocell gateway entity and/or in the public land mobile network.

4-5. (canceled)

6. The method according to claim 1, wherein the public land mobile network comprises a position information related to a current position of the femtocell base station, and wherein the method further comprises:
based on determining that the at least one previous location information matches the at least one permission information, preventing subsequent determinations of whether previous location information matches permission information the location update signalling procedure between the femtocell base station and the user equipment.

7. A femtocell base station to be used with a public land mobile network, wherein the femtocell base station is connected to the public land mobile network via a femtocell gateway entity, wherein at least one permission information is related to the femtocell base station, wherein the femtocell base station is configured such that a location update signalling procedure is initiated between the femtocell base station and the user equipment, wherein at least one previous location information of the user equipment is transmitted from the user equipment to the femtocell base station, the at least one previous location information being derived from or being a part of an indication regarding a last successfully visited location of the user equipment, wherein the femtocell base station is furthermore configured to determine whether the at least one previous location information matches the at least one permission information, and wherein the femtocell base station is furthermore configured to continue the location update signalling procedure based on the at least one previous location information matching the at least one permission information, and to discontinue the location update signalling procedure based on the at least one previous location information not matching the at least one permission information,
wherein the at least one permission information corresponds to at least one Mobile Country Code or to at least one Mobile Country Code and Mobile Network Code, and wherein the at least one previous location information corresponds to a Mobile Country Code or to a Mobile Country Code and a Mobile Network Code of the last successfully visited location of the user equipment.

8-9. (canceled)

10. A non-transitory, processor-readable medium having processor-executable instructions stored thereon for using a femtocell base station and a user equipment in a public land mobile network, wherein the femtocell base station is connected to the public land mobile network via a femtocell gateway entity, wherein at least one permission information is related to the femtocell base station, and wherein the processor-executable instructions comprise instructions for:
initiating a location update signalling procedure between the femtocell base station and the user equipment, wherein at least one previous location information of the user equipment is transmitted from the user equipment to the femtocell base station, the at least one previous location information being derived from or being a part of an indication regarding a last successfully visited location of the user equipment;
determining whether the at least one previous location information matches the at least one permission information;
continuing the location update signalling procedure in response to determining that the at least one previous location information matches the at least one permission information; and
discontinuing the location update signalling procedure in response to determining that the at least one previous location information does not match the at least one permission information;
wherein the at least one permission information corresponds to at least one Mobile Country Code or to at least one Mobile Country Code and Mobile Network Code, and wherein the at least one previous location information corresponds to a Mobile County Code or to a Mobile Country Code and a Mobile Network Code of the last successfully visited location of the user equipment.

11. (canceled)

12. The method according to claim 1, further comprising:
based on determining that the at least one previous location information does not match the at least one permission information, changing the femtocell base station to a closed mode of operation such that access to the public land mobile network via the femtocell base station is possible only for a predefined set of other user equipment.

13. The method according to claim 1, further comprising:
based on determining that the at least one previous location information does not match the at least one permission information, changing the femtocell base station to a reduced mode of operation for the user equipment.

14. The method according to claim 1, further comprising:
based on determining that the at least one previous location information does not match the at least one permission information, disabling the radio interface of the femtocell base station.

15. The method according to claim 1, further comprising:
based on determining that the at least one previous location information does not match the at least one permission information, changing a counter related to unsuccessful matching between the at least one previous location information of the user equipment and the at least one permission information.

16. The method according to claim 1, further comprising:
based on determining that the at least one previous location information does not match the at least one permission information, sending a message related to the unsuccessful match between the at least one previous location information of the user equipment and the permission information to a predefined target address.
